(19) United States
(12) Patent Application Publication
(10) Pub. No.: US 2008/0313799 A1
(43) Pub. Date: Dec. 25, 2008

(54) Steam and sauna apparatus

(76) Inventor: Huan Nguyen, Huntington Beach, CA (US)

Correspondence Address: TY UNG, 16830 VENTURA BLVD., SUITE 360, ENCINO, CA, 91436, US

(21) Appl. No.: 11/820,319

(22) Filed: Jun. 19, 2007

(51) Int. Cl. A61H 33/06

(52) U.S. Cl. 4/533

(57) ABSTRACT

An apparatus for converting a normal shower room into a steam and sauna facility. The apparatus mainly comprises a vertical panel, a rain shower, a hand held massage means, a back and foot massage means, a seat with seat massage means, and steam and heat generating means. The apparatus also includes an electronic device incorporating radio and telephone features and buttons for controlling steam, heat and massage means.

### CROSS-REFERENCE TO RELATED APPLICATION

This application claims priority to provisional application No. 60/814,354 filed on Jun. 16, 2006.

### FEDERALLY SPONSORED RESEARCH

Not Applicable

### SEQUENCE LISTING OR PROGRAM

Not Applicable

### STATEMENT REGARDING COPYRIGHTED MATERIAL

Portions of the disclosure of this patent document contain material that is subject to copyright protection. The copyright owner has no objection to the facsimile reproduction by anyone of the patent document or the patent disclosure as it appears in the Patent and Trademark Office file or records, but otherwise reserves all copyright rights whatsoever.

### BACKGROUND

The present invention relates in general to shower systems, and more particularly to an apparatus for converting a normal shower into a steam, sauna and massage facility.

Several shower systems have been developed in the art. For example, U.S. Pub. No. 20060248640 to Leong discloses an apparatus able to convert a conventional stall shower into a multi-purpose shower facility, including a steam bath, a handheld shower, a water massage and a rain shower. It can be used with either single water input line or two separate hot and cold water input lines. The single water input line fit with the single output line of a common stall shower. To match different situations, two types of steam generator are also disclosed.

U.S. Pat. No. 3,936,891 to Kulde discloses a shower spray massage-sauna equipment suitable for installation into existing bathrooms by adding a water diverter valve between the shower head and the shower arm pipe and using a connecting hose to direct the water from the shower head to the shower spray massage-sauna spray arm. This spray arm is mounted on the wall opposite to the shower water control valves to allow the user to sit on a seat and to control the temperature and the force of the water. This spray arm also supports the flexible body enclosing cover and is adjustable to suit the height of the person using it. The cover has a round opening for the head at the top and partable opening at the front to permit the entry and the exit of the user. This equipment can be left in the bathroom in the non-use position or it can be easily removed to allow the normal use of the bathtub or the shower.

U.S. Pub. No. 20060207014 to DeBoer discloses a shower system that provides a corner shower unit which includes a track defined along a vertical height thereof. A lumbar support and a multitude of showerheads are mounted to the track for vertical adjustment. The lumbar support permits a bather standing in the shower to lean against the lumbar support while a multitude of spray jets provide a massage action directly to the bather. A steam generation system is incorporated into the corner shower unit to mist steam from steam ports such that the shower may also be utilized as a steam room. However, the above apparatuses have different setup for providing steam bath and body massage compared to the present invention.

The object of the present invention is to provide an apparatus for converting a normal shower into a multi-purpose facility with steam, sauna and massage features. The apparatus also includes entertainment and communication features such as radio, telephone and input sockets for audio or video devices. Other objects of the present invention will become better understood with reference to the appended Summary, Description, and Claims.

### SUMMARY

The present invention is an apparatus for converting a normal shower into a steam, sauna and massage facility. The apparatus comprises a vertical panel, a rain shower, a hand held massage means, a back and foot massage means, a seat with seat massage means, a steam generator and a heat generator. Steam and heat generated are circulated in the shower room to provide the necessary conditions for a steam and sauna bath, respectively. The massage means comprises water jet massage.

### BRIEF DESCRIPTION OF THE FIGURES

FIGS. 1 and 2 are perspective views of the apparatus of the present invention.

FIG. 3 is a perspective view of the top portion of the apparatus.

FIGS. 4 and 5 are perspective views of the mid portions of the panel of the apparatus.

FIG. 6 is a perspective view of the seat portion of the apparatus.

### FIGURES—REFERENCE NUMERALS

10 . . . Apparatus
12 . . . Panel
14 . . . Rain Shower
16 . . . Hand Held Water Jet Massager
18 . . . Water Jet Foot Massager
20 . . . Seat
22 . . . Water Jet Massager
24 . . . Entertainment Means
26 . . . Button
28 . . . Knob
30 . . . Shower Room
32 . . . Screen

### DETAILED DESCRIPTION

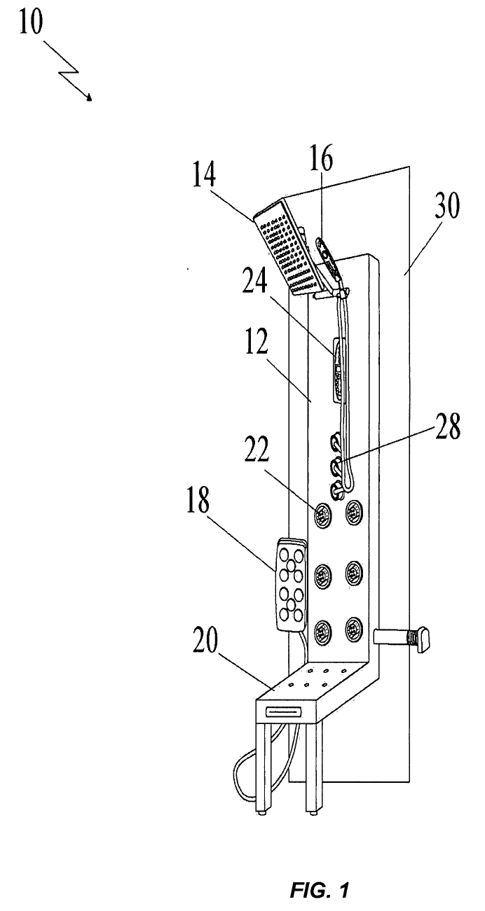

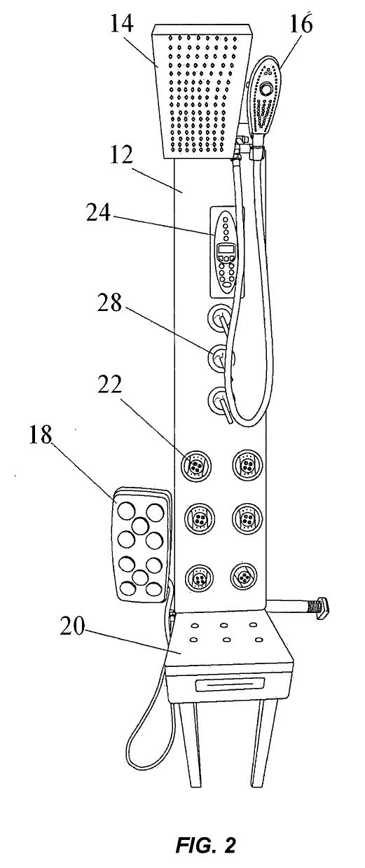

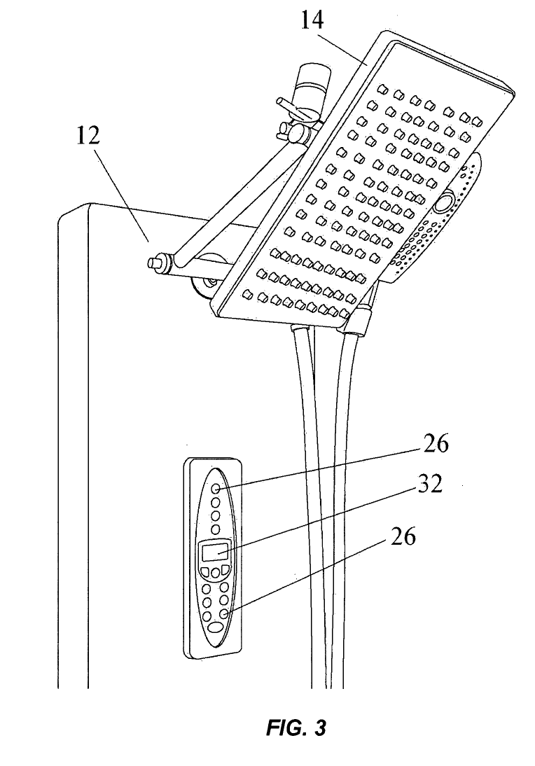

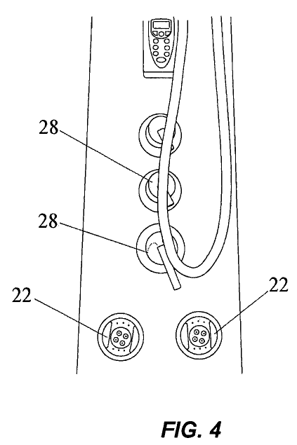

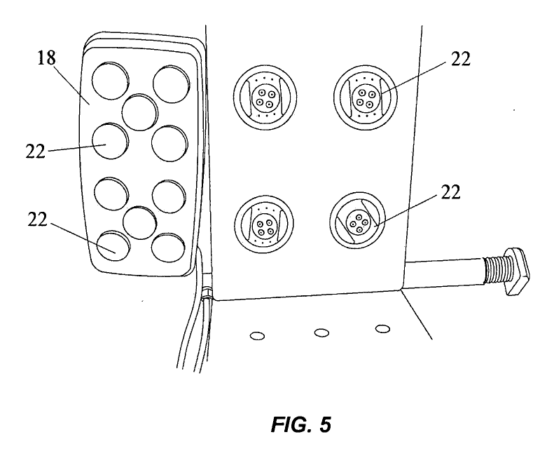

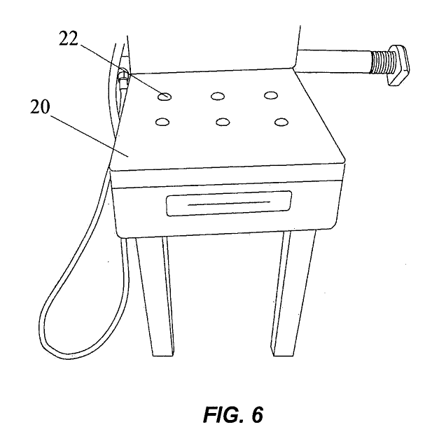

Referring to the drawings, a preferred embodiment of the apparatus of the present invention is illustrated and generally indicated as 10 in FIGS. 1 through 6. The apparatus converts a shower room 30 into a steam and sauna room with massage features. The apparatus can be made in various sizes and of different materials.

Referring to FIGS. 1 through 6, the apparatus 10 comprises a panel 12, a rain shower 14 on top of the panel, a hand held water jet massager 16, a foot massager 18, a seat 20, a steam generator and a heat generator. The steam and heat generators (not shown) are located outside, away from the panel and the seat. The panel 12, foot massager and seat 20 include water jet massagers 22. The massagers on the panel are adapted for massaging the back of a user when seated. When not in use, the hand held massager 16 is hung to the top portion of the panel and the foot massager 18 is hung beside the panel 12. An acrylic sheet (not shown) can be used to cover the top of the shower room for preventing the escape of steam and heat. The panel also includes knobs 28 for controlling water flow.

Referring to FIGS. 1 through 3, the apparatus 10 further comprises an entertainment means 24 namely, electronic devices which incorporates radio, telephone and CD player hookup which allows a user to hook up their own CD player and use the installed speaker to listen to music. The ozone sterilizer in the back of the system (not shown) provides a bacteria free environment by killing bacteria. A shampoo rack (not shown) may also be installed. To control the electronic devices, a control means, such as a remote control (not shown) may also be provided.

The electronic device 24 includes a screen 32 and a control panel for radio and telephone operations and for controlling steam and temperature. The control panel includes buttons 26 to adjust the volume, change radio stations, select temperature, select time for steam and heat circulation, adjust water jet pressure and operate the shower. The same buttons which perform the above operations are used for telephone operations.

All features disclosed in this specification, including any accompanying claims, abstract, and drawings, may be replaced by alternative features serving the same, equivalent or similar purpose, unless expressly stated otherwise. Thus, unless expressly stated otherwise, each feature disclosed is one example only of a generic series of equivalent or similar features.

Any element in a claim that does not explicitly state “means for” performing a specified function, or “step for” performing a specific function, is not to be interpreted as a “means” or “step” clause as specified in 35 U.S.C. § 112, paragraph 6. In particular, the use of “step of” in the claims herein is not intended to invoke the provisions of 35 U.S.C. § 112, paragraph 6.

Although preferred embodiments of the present invention have been shown and described, various modifications and substitutions may be made thereto without departing from the spirit and scope of the invention. Accordingly, it is to be understood that the present invention has been described by way of illustration and not limitation.

What is claimed is:

1. An apparatus for converting a normal shower room into a steam and massage facility, comprising:
a panel including at least one shower means and a means for controlling water flow;
a means for generating steam;
a plurality of massage means on the panel;
an entertainment means; and
a control means, wherein the apparatus is set up in an enclosed shower room.

2. The apparatus of claim 1, wherein the entertainment means comprises a radio and a means for connecting electronic devices such as audio and video devices.

3. The apparatus of claim 2, wherein the control means is used to adjust volume, change radio channels, to select temperature and time and to operate shower.

4. The apparatus of claim 1, wherein the apparatus further comprises a hands free telephone, a television, a shampoo rack, and an ozone sterilizer.

5. The apparatus of claim 4, wherein the control means is used to operate the telephone.

6. The apparatus of claim 1, wherein the massage means on the panel are adapted for massaging the back of a user.

7. The apparatus of claim 1, wherein the massage means comprises water jet massage means.

8. The apparatus of claim 7, wherein the control means is used to adjust water pressure.

9. The apparatus of claim 1, wherein the apparatus further comprises a hand-held massage means and a foot massage means, wherein the foot massage means and the hand held massage means are adapted to be hanged when not in use.

10. The apparatus of claim 1, wherein the top of the shower room is covered with an acrylic sheet to enclose the shower room and prevent leakage of steam.

11. The apparatus of claim 1, wherein the at least one shower means comprises a rain shower.

12. The apparatus of claim 1, further comprising a seating structure in connection with the panel.

13. The apparatus of claim 12, wherein the seating structure comprises a plurality of massaging means.

14. An apparatus for converting a normal shower room into a sauna and massage facility, comprising:
a panel including at least one shower means and a means for controlling water flow;
a means for generating heat;
a plurality of massage means on the panel and the seating structure;
an entertainment means; and
a control means, wherein the apparatus is set up in an enclosed shower room.

15. The apparatus of claim 14, wherein the entertainment means comprises a radio and a means for connecting electronic devices such as audio and video devices.

16. The apparatus of claim 15, wherein the control means is used to adjust volume, change radio channels, to select temperature and time and to operate shower.

17. The apparatus of claim 14, wherein the apparatus further comprises a hands free telephone, a television, a shampoo rack, and an ozone sterilizer.

18. The apparatus of claim 17, wherein the control means is used to operate the telephone.

19. The apparatus of claim 14, wherein the massage means on the panel are adapted for massaging the back of a user.

20. The apparatus of claim 14, wherein the massage means comprises water jet massage means.

21. The apparatus of claim 20, wherein the control means is used to adjust water pressure.

22. The apparatus of claim 14, wherein the apparatus further comprises a hand-held massage means and a foot massage means, wherein the foot massage means and the hand held massage means are adapted to be hang when not in use.

23. The apparatus of claim 14, wherein the top of the shower room is covered with an acrylic sheet to enclose the shower room.

24. The apparatus of claim 14, wherein the at least one shower means comprises a rain shower.

25. The apparatus of claim 14, further comprising a seating structure in connection with the panel.

26. The apparatus of claim 25, wherein the seating structure comprises a plurality of massaging means.
